(19) United States
(12) Patent Application Publication
(10) Pub. No.: US 2020/0265575 A1
(43) Pub. Date: Aug. 20, 2020

(54) FLAW INSPECTION APPARATUS AND METHOD

(71) Applicant: Fanuc Corporation, Yamanashi (JP)

(72) Inventor: Yuusuke OOTA, Yamanashi (JP)

(73) Assignee: Fanuc Corporation, Yamanashi (JP)

(21) Appl. No.: 16/740,697

(22) Filed: Jan. 13, 2020

(30) Foreign Application Priority Data
Feb. 14, 2019 (JP) 2019-024369

(51) Int. Cl. G06T 7/00; G06T 7/62; G06N 3/08; G01N 21/88

(52) U.S. Cl. CPC G06T 7/0008; G06T 7/62; G06N 3/08; G01N 2021/8887; G06T 2207/20081; G01N 2021/8874; G01N 21/8851

(57) ABSTRACT

A flaw inspection apparatus according to the present invention includes a deep learning unit to which an image obtained by photographing a surface of an inspection object is input and in which, on the basis of the input image, the deep learning unit judges absence or presence of a flaw on a surface of the inspection object and specifies a site judged as being the flaw; a dimension measuring unit that measures a dimension of the flaw on the basis of the image of the site specified by the deep learning unit; and a flaw classifying unit that classifies the flaw on the basis of the dimension of the flaw measured by the dimension measuring unit.

### CROSS-REFERENCE TO RELATED APPLICATIONS

This application is based on Japanese Patent Application No. 2019-024369, the contents of which are incorporated herein by reference.

### TECHNICAL FIELD

The present disclosure relates to a flaw inspection apparatus and a flaw inspection method.

### BACKGROUND ART

An automatic inspection apparatus that inspects an inspection object by using deep learning in a neural network is known (for example, see Japanese Unexamined Patent Application, Publication No. 2003-76991).

### SUMMARY OF INVENTION

According to an aspect of the present disclosure, there is provided a flaw inspection apparatus including: a deep learning unit to which an image obtained by photographing a surface of an inspection object is input, in which, on the basis of the input image, the deep learning unit judges absence or presence of a flaw on a surface of the inspection object and specifies a site judged as being the flaw; a dimension measuring unit that measures a dimension of the flaw on the basis of the image of the site specified by the deep learning unit; and a flaw classifying unit that classifies the flaw on the basis of the dimension of the flaw measured by the dimension measuring unit.

### BRIEF DESCRIPTION OF DRAWINGS

FIG. 1 is a block diagram indicating a flaw inspection apparatus according to one embodiment of the present disclosure.

FIG. 2 is a diagram illustrating one example of an image obtained by a camera in the flaw inspection apparatus illustrated in FIG. 1.

FIG. 3 is a diagram illustrating rectangular regions that include sites judged as being flaws and that are obtained by inputting the image illustrated in FIG. 2 into a deep learning unit.

FIG. 4 illustrates an image example in which the probability of the rectangular region A illustrated in FIG. 3 having a flaw is expressed in grayscale.

FIG. 5 illustrates an image example in which the probability of the rectangular region B illustrated in FIG. 3 having a flaw is expressed in grayscale.

FIG. 6 illustrates an image example of a binary image obtained by binarizing the image illustrated in FIG. 4.

FIG. 7 illustrates an image example of a binary image obtained by binarizing the image illustrated in FIG. 5.

FIG. 8 is a flowchart indicating a flaw inspection method that uses the flaw inspection apparatus illustrated in FIG. 1.

FIG. 9 is a block diagram indicating a modification of the flaw inspection apparatus illustrated in FIG. 1.

### DESCRIPTION OF EMBODIMENTS

A flaw inspection apparatus 1 and a flaw inspection method according to one embodiment of the present disclosure will now be described with reference to the drawings.

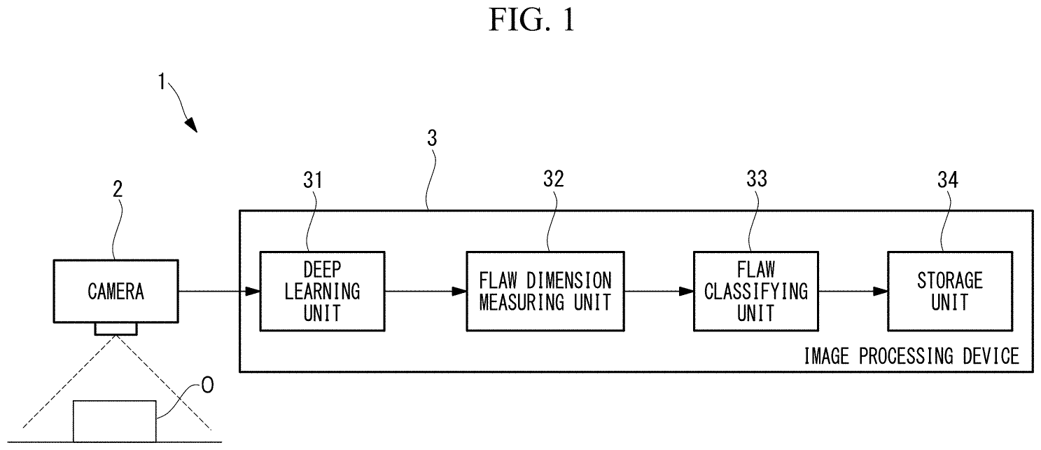

As illustrated in FIG. 1, the flaw inspection apparatus 1 according to this embodiment is equipped with a camera 2 that photographs an inspection object O, and an image processing device 3 that processes an image (two-dimensional image) P1 obtained by the camera 2.

The image processing device 3 is equipped with a deep learning unit 31 to which the image P1 obtained by the camera 2 is input; a flaw dimension measuring unit (dimension measuring unit) 32 that calculates a dimension of a flaw from the image output from the deep learning unit 31; a flaw classifying unit 33 that classifies the flaw on the basis of whether or not the calculated dimension of the flaw exceeds a predetermined threshold; and a storage unit 34 that stores the flaw and the dimension in association with each other. The deep learning unit 31, the flaw dimension measuring unit 32, and the flaw classifying unit 33 are each constituted by a processor, and the storage unit 34 is constituted by a memory.

In the deep learning unit 31, images P1 of a large number of inspection objects O obtained in advance and the information about absence or presence of flaws in the images P1 are input to enable deep learning and configure a learning model.

Since the information used to configure the learning model only needs to be information about whether there are flaws or not, there is no need to measure the dimensions of the flaws, and, thus, the learning task is simple.

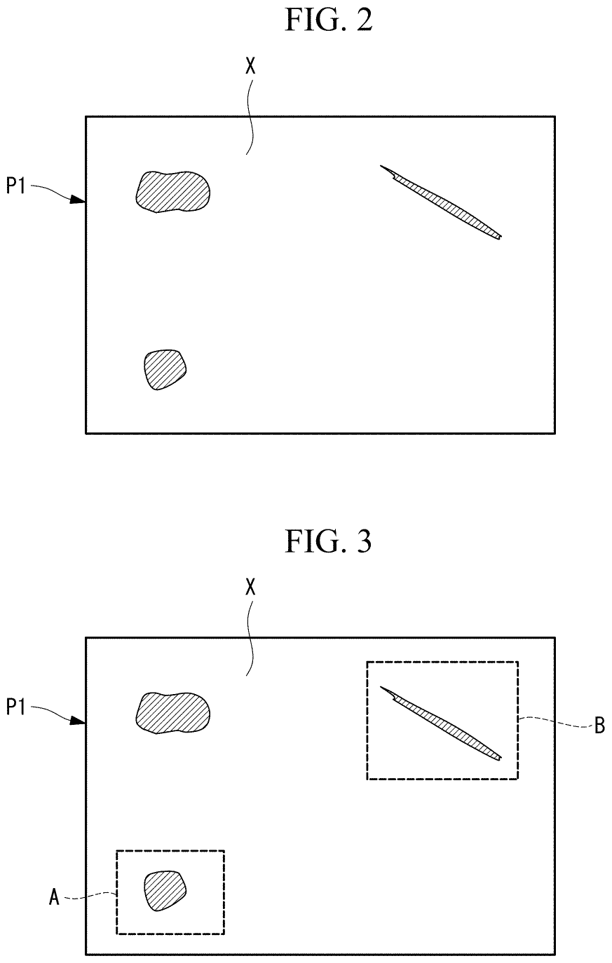

When an image P1 obtained by the camera 2 is input to the learning model in the deep learning unit 31, absence or presence of flaws on the surface of the inspection object O in the image P1 is judged. FIG. 2 illustrates an image P1 obtained by the camera 2, and FIG. 3 illustrates the image P1 obtained by the camera 2 in which information about positions of rectangular regions A and B containing sites judged as being flaws is specified by the deep learning unit 31.

The deep learning unit 31 then outputs information about the probability of there being a flaw for each of the pixels in the rectangular regions A and B.

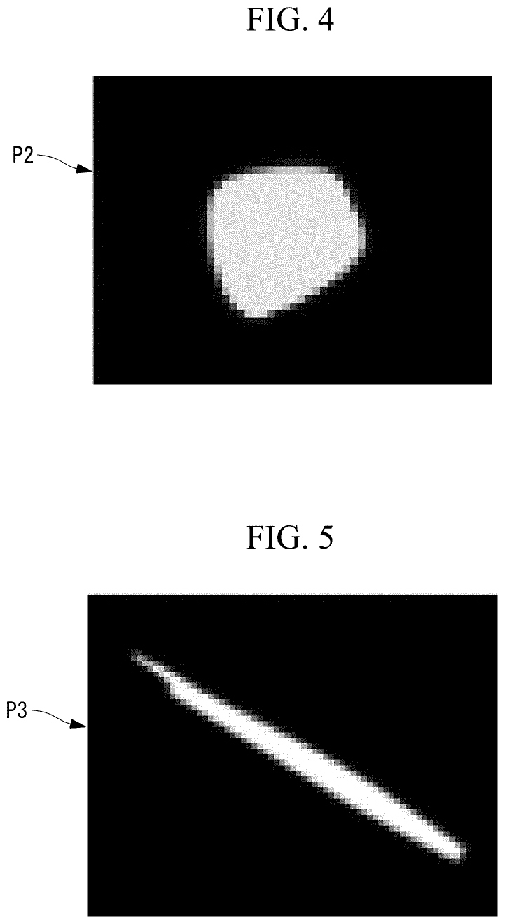

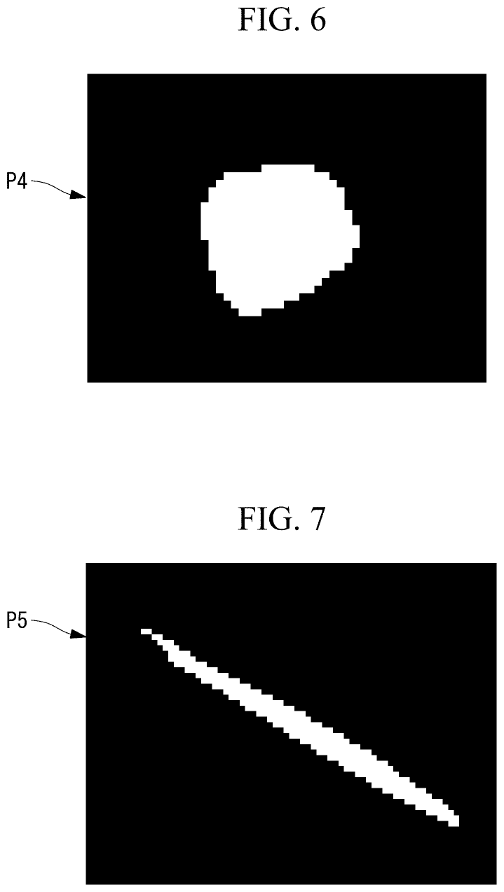

As illustrated in FIGS. 4 and 5, images P2 and P3 in which portions with high probabilities of being flaws are indicated in lighter shades and those with low probabilities of being flaws are indicated in darker shades are generated in the flaw dimension measuring unit 32 on the basis of the information output from the deep learning unit 31. Furthermore, as illustrated in FIGS. 6 and 7, the generated images P2 and P3 are binarized by a predetermined threshold to generate binary images P4 and P5.

For each of white pixel regions in the generated binary images P4 and P5, the flaw dimension measuring unit 32 calculates at least one of the length in the longitudinal direction, the length in a direction orthogonal to the longitudinal direction, the perimeter, and the area.

The flaw classifying unit 33 compares the threshold and the dimension calculated in the flaw dimension measuring unit 32. The threshold is a value for judging, for example, whether repair is possible or whether shipment is possible, and can be set as desired.

In other words, flaws that have lengths, perimeters, or areas that are less than a predetermined threshold can be classified as repairable or acceptable for shipment, and flaws that have lengths, perimeters, or areas that are equal to or greater than the threshold can be classified as unrepairable or unacceptable for shipment.

The storage unit 34 stores the classified flaws in association with the dimensions measured by the flaw dimension measuring unit 32.

A flaw inspection method that uses the flaw inspection apparatus 1 of the present embodiment having the above-described features will now be described.

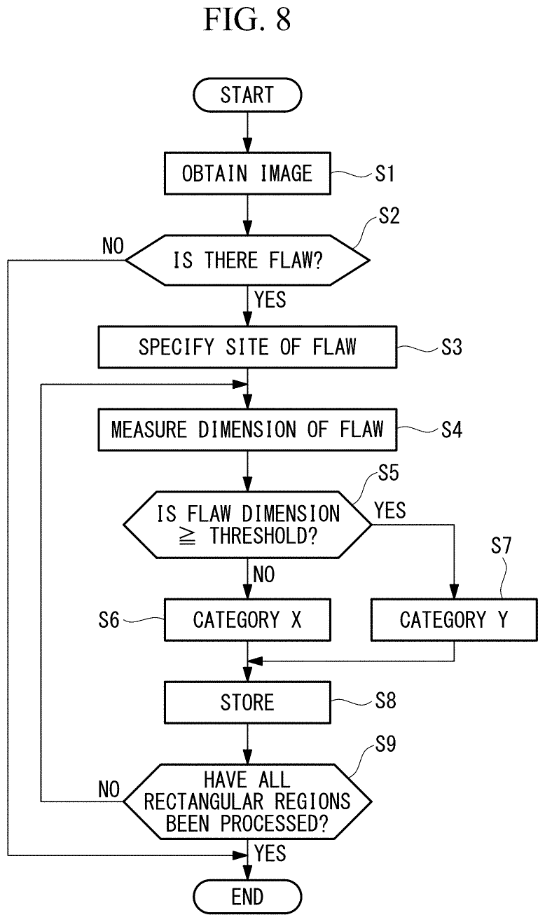

As illustrated in FIG. 8, the flaw inspection method of this embodiment involves photographing an inspection object O with the camera 2 to obtain an image P1 (step S1), and inputting the obtained image P1 to the deep learning unit 31. In the deep learning unit 31, absence or presence of flaws on the surface of the inspection object O is judged (step S2), and the sites judged as flaws are specified (step S3).

When there are no sites judged as being flaws in step S2, the process is ended. When there are sites judged as being flaws, information regarding the probability of a flaw being present is output to the flaw dimension measuring unit 32 for each of the rectangular regions A and B containing these sites, and, for each flaw, at least one of the length, perimeter, and area is calculated in the flaw dimension measuring unit 32 (step S4).

Next, whether the calculated dimension is equal to or greater than a threshold is judged in the flaw classifying unit 33 (step S5), and the flaws are classified into two categories, X and Y, respectively corresponding to flaws that have a dimension less than the threshold and flaws that have a dimension equal to or greater than the threshold (steps S6 and S7). The classified flaws are stored in the storage unit 34 in association with the dimensions of the flaws measured in the flaw dimension measuring unit 32 (step S8).

When not all of the rectangular regions A and B are classified, the steps from step S4 are repeated for the next rectangular regions A and B (step S9).

According to the flaw inspection apparatus 1 and the flaw inspection method of this embodiment, absence or presence of flaws is judged by deep learning from an image P1 obtained by the camera 2. Thus, absence or presence of flaws can be judged and the sites thereof can be specified without clearly defining what flaws are. In other words, according to deep learning, whether the concerned object is a flaw or attached matter such as dust can be easily learned, and the absence or presence of flaws in the input image P1 can be easily judged.

The sites judged as being flaws are subjected to image processing in the flaw dimension measuring unit 32 to measure at least one of the length, perimeter, and area for each flaw. Thus, the flaws can be easily classified in the flaw classifying unit 33.

In this case, a site judged as being a flaw in deep learning is measured to determine the dimension of the flaw by image processing. Thus, there is an advantage in that there is no need to use dimensions of flaws in the learning stage of deep learning, and thus learning can be completed easily and in a short time. Another advantage is that when the measured dimension is less than a threshold, and when, for example, the flaw is classified as acceptable for shipment, the flaw and the dimension in association with each other are stored in the storage unit 34, and thus the traceability after shipment can be improved. Yet another advantage is that the shipment standard can be adjusted by changing the threshold of the dimension of the flaw without having to perform the learning again.

In this embodiment, in the flaw dimension measuring unit 32, at least one of the length, perimeter, and area of a flaw is calculated, and the calculated dimension is compared with a threshold to classify the flaw into two categories, X and Y. Alternatively, all of the length, perimeter, and area of a flaw may be calculated, and the flaw may be classified into two categories, X and Y, on the basis of whether any one of these values is equal to or greater than the corresponding threshold. Depending on the types of dimensions that exceed the thresholds, the flaw may be classified into three or more categories.

In this embodiment, images P2 and P3 generated from the information indicating the probability of constituting a flaw output from the deep learning unit 31 is binarized, and the dimensions are measured from these binary images; alternatively, the image P1 obtained by the camera 2 may be directly subjected to image processing so as to extract the edge of a flaw and calculate at least one of the length, perimeter, and area of the flaw by using the extracted edge.

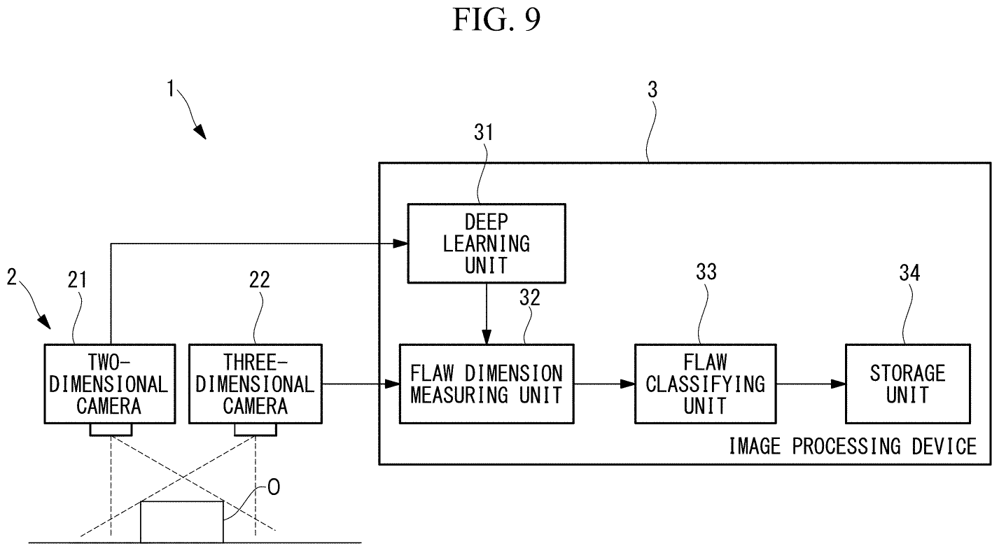

In this embodiment, the camera 2 captures a two-dimensional image P1; alternatively, the camera 2 may capture a two-dimensional image and a three-dimensional image. As illustrated in FIG. 9, the camera 2 may be equipped with both a two-dimensional camera 21 and a three-dimensional camera 22 so as to capture a two-dimensional image and a three-dimensional image by switching between these cameras. Alternatively, two two-dimensional images with different parallaxes may be obtained so as to form a three-dimensional image from the two two-dimensional images.

In such a case, as illustrated in FIG. 9, in the deep learning unit 31, the two-dimensional images may be used to judge absence or presence of a flaw and to specify the site of the flaw, and, in the flaw dimension measuring unit 32, the three-dimensional image may be used to measure the depth of the flaw.

In this manner, the depth can be used as the standard for classifying the flaw. In the flaw dimension measuring unit 32, both a two-dimensional image and a three-dimensional image may be used to use at least one of the length, perimeter, area, and depth of the flaw to classify the flaw.

In this embodiment, a moving mechanism that moves the three-dimensional camera 22 may be provided. In this manner, the three-dimensional camera 22 can be moved by the moving mechanism on the basis of the position information of the flaw obtained from the two-dimensional image, and thus a three-dimensional camera 22 having a narrower field of view (for example, a camera with a higher resolution but with a narrower field of view) than the two-dimensional camera 21 can be used.

### REFERENCE SIGNS LIST

1 flaw inspection apparatus
31 deep learning unit
32 flaw dimension measuring unit (dimension measuring unit)
33 flaw classifying unit
34 storage unit
O inspection object
P1 image (two-dimensional image)

1. A flaw inspection apparatus comprising:
a deep learning unit to which an image obtained by photographing a surface of an inspection object is input, in which, on the basis of the input image, the deep learning unit judges absence or presence of a flaw on a surface of the inspection object and specifies a site judged as being the flaw;
a dimension measuring unit that measures a dimension of the flaw on the basis of the image of the site specified by the deep learning unit; and
a flaw classifying unit that classifies the flaw on the basis of the dimension of the flaw measured by the dimension measuring unit.

2. The flaw inspection apparatus according to claim 1, wherein the dimension measuring unit measures at least one of a length and an area of the flaw in a binary image obtained by binarizing pixel values used in judging absence or presence of the flaw in the deep learning unit.

3. The flaw inspection apparatus according to claim 1, wherein the dimension measuring unit extracts an edge of the flaw in the image and measures at least one of a length and an area of the flaw on the basis of the extracted edge.

4. The flaw inspection apparatus according to claim 1, wherein the input image includes a two-dimensional image and a three-dimensional image;
on the basis of the two-dimensional image, the deep learning unit judges absence or presence of the flaw on the surface of the inspection object and specifies the site judged as being the flaw, and
on the basis of the three-dimensional image, the dimension measuring unit measures a depth of the flaw at the site specified by the deep learning unit.

5. The flaw inspection apparatus according to claim 1, further comprising a storage unit that stores the flaw classified by the flaw classifying unit in association with the dimension of the flaw measured by the dimension measuring unit.

6. A flaw inspection method comprising:
inputting an image obtained by photographing a surface of an inspection object;
on the basis of the input image, judging absence or presence of a flaw on the surface of the inspection object and specifying a site judged as the flaw;
measuring a dimension of the flaw on the basis of the image of the specified site; and
classifying the flaw on the basis of the measured dimension of the flaw.
